(19) United States
(12) Patent Application Publication
(10) Pub. No.: US 2023/0086509 A1
(43) Pub. Date: Mar. 23, 2023

(54) TEMPERATURE PROBE AND INTELLIGENT COOKING UTENSIL WITH THE SAME

(71) Applicant: SHENZHEN H-ONE ELECTRICAL APPLIANCES CO., LTD., Guangdong (CN)

(72) Inventors: Shijun GUO, Guangdong (CN); Binjie LI, Guangdong (CN)

(73) Assignee: SHENZHEN H-ONE ELECTRICAL APPLIANCES CO., LTD., Guangdong (CN)

(21) Appl. No.: 17/528,139

(22) Filed: Nov. 16, 2021

Related U.S. Application Data
(63) Continuation of application No. PCT/CN2021/118993, filed on Sep. 17, 2021.

(51) Int. Cl. G01K 1/14; G01K 13/00; H02J 50/10; H02J 50/00; A47J 36/06; A47J 36/32

(52) U.S. Cl. CPC G01K 1/14; G01K 13/00; H02J 50/10; H02J 50/005; A47J 36/06; A47J 36/32; G01K 2207/06; A47J 2202/00

(57) ABSTRACT

The present application relates to a temperature probe and an intelligent cooking utensil with the same. The temperature probe includes a housing, a temperature sensing element, and a metal head fixedly arranged on the housing; one end of the metal head is connected to the temperature sensing element; a wireless charging coil, a rechargeable battery and a support frame for supporting the wireless charging coil and the rechargeable battery are arranged in the housing; the temperature sensing element is electrically connected to a charging circuit of the rechargeable battery; and the wireless charging coil is electrically connected to the rechargeable battery so as to charge the rechargeable battery. When the power of the rechargeable battery is relatively low or used up, a user may put the temperature probe on a wireless charging mount to charge the rechargeable battery.

### CROSS-REFERENCE TO RELATED APPLICATION

The present application is a continuation of international application of PCT application No. PCT/CN2021/118993 filed on Sep. 17, 2021. The entirety of the above-mentioned patent application is incorporated herein by reference and made a part of this specification.

### TECHNICAL FIELD

The present application relates to the field of intelligent cooking systems and matching equipment thereof, in particular to a temperature probe and an intelligent cooking utensil with the same.

### BACKGROUND ART

At present, an intelligent cooking utensil has been used in many restaurants or at home. The intelligent cooking utensil may automatically cook food material into cooked food according to different cooking modes, which is based on the main principle that the food material is at the corresponding temperature within different cooking time according to a preset cooking mode, and one of core steps of the intelligent cooking utensil is to acquire the temperature of the food material in real time in an automatic cooking process.

In the prior art, the intelligent cooking utensil may be generally provided with an intelligent probe on a pot cover, a temperature sensor is arranged in a needle point part of the intelligent probe, and the intelligent probe abuts against the food material by the needle point part and acquires temperature data of the food material in real time by the temperature sensor.

The intelligent probe is generally powered by a battery, however, the capacity of the battery is limited, and the battery is required to be replaced after being used up, so that the disposable use cost is relatively high; and meanwhile, the battery of which the power is used up is generally discarded, which easily causes environment pollution and is not environmentally friendly.

### SUMMARY

A first aspect of the present application is to provide a temperature probe having the characteristics that the disposable use cost is reduced and the environmental friendliness is higher.

The above-mentioned first inventive aspect of the present application is achieved by the following technical solution: provided is a temperature probe, including a housing, a metal head fixedly arranged on the housing, and a temperature sensing element arranged in the metal head; a wireless charging coil, a rechargeable battery and a support frame for supporting the wireless charging coil and the rechargeable battery are arranged in the housing; the temperature sensing element is electrically connected to a charging circuit of the rechargeable battery; and the wireless charging coil is electrically connected to the rechargeable battery so as to charge the rechargeable battery.

By adopting the above-mentioned technical solution, the metal head is used to abut against a food material and transfer heat to the temperature sensing element in real time, so that the temperature sensing element is capable of measuring the temperature of the food material in real time. The rechargeable battery is used for supplying power to the temperature sensing element to maintain the normal work of the temperature sensing element. When the power of the rechargeable battery is relatively low or used up, a user may put the temperature probe on a wireless charging mount and make the wireless charging coil close to a charging region of the wireless charging mount to charge the rechargeable battery. The rechargeable battery in the temperature probe can be repeatedly charged, so that the frequency that the battery needs to be replaced by the user is reduced, the disposable use cost is reduced, meanwhile, the discard rate of the battery is reduced, and environment pollution is relieved.

In some embodiments, the support frame includes a plurality of first engagement portions, and a plurality of engagement slots for engaging and matching the adjacent first engagement portions are formed in the inner side of the housing.

By adopting the above-mentioned technical solution, the support frame is engaged into the housing by the first engagement portions so as to be conveniently mounted or dismounted by a user.

In some embodiments, the support frame includes a limiting block, a limiting slot for limiting the limiting block is formed in the housing, and the sliding block is slidably connected to the inside of the limiting slot; and the positions of the engagement slots pass by sliding paths of the first engagement portions.

By adopting the above-mentioned technical solution, when the temperature probe is produced and assembled by a manufacturer, the limiting block is capable of sliding into the limiting slot, and the support frame may be gradually and completely pushed into the housing. When the first engagement portions pass by the adjacent engagement slots, the first engagement portions may be engaged with the adjacent engagement slots with the further movement of the support frame, so that fixation between the support frame and the housing is achieved, it is convenient for a user to perform mounting, and the production efficiency is increased.

In some embodiments, the housing includes a head sealing ring for sealing a gap between the metal head and the housing, and the support frame includes an abutting sealing portion for abutting against the head sealing ring to achieve a sealing effect.

By adopting the above-mentioned technical solution, when the support frame is engaged and fixedly arranged in the housing, the head sealing ring abuts against the support frame to ensure that the support frame and the housing may be stably kept in an engagement state, so that the durability of the temperature probe is improved. When being abutted against, the head sealing ring may deform in the housing to fill the gap between the housing and the metal head, thereby improving the sealing property of the temperature probe and stopping water or sundries from entering the housing.

In some embodiments, the housing includes a mounting cavity for accommodating the support frame, one end of the mounting cavity is provided with a mounting opening allowing the support frame to enter and exit, an accommodating space for accommodating the wireless charging coil is arranged between the mounting opening and an end of the support frame, and a rear cover for shielding the accommodating space is detachably mounted in the mounting opening.

By adopting the above-mentioned technical solution, when the temperature probe is produced and assembled by a manufacturer, firstly, the support frame may be mounted into the mounting cavity via the mounting opening, next, the wireless charging coil is mounted in the accommodating space, and then, the rear cover is mounted and fixedly arranged in the mounting opening, so that the support frame and the wireless charging coil are fixedly arranged in the mounting cavity, and the assembly and production efficiencies are increased.

In some embodiments, the support frame includes a plurality of first engagement portions, and a plurality of engagement slots for engaging and matching the adjacent first engagement portions are formed in the inner side of the housing; the support frame includes connecting pieces for connecting the first engagement portions, the rear cover includes mounting blocks having a function of limiting the connecting pieces; and the connecting pieces are provided with second engagement portions, and the mounting blocks are provided with engagement holes for engaging the adjacent second engagement portions.

By adopting the above-mentioned technical solution, after the mounting of the rear cover, the housing and the support frame is completed, the mounting blocks stop the connecting pieces from moving to a direction away from the engagement slots, the first engagement portions are stopped from being separated from the engagement slots, and then, the support frame and the housing may be still kept in a relatively fixed state in a shaking environment, so that the working stability of the temperature probe is improved. The rear cover is fixedly arranged on the support frame in an engagement manner so as to be conveniently mounted or dismounted by a user.

In some embodiments, the support frame includes a first supporting piece, a second supporting piece assembled and matched with the first supporting piece, and fixing pieces for detachably fixing the first supporting piece and the second supporting piece; and an accommodating cavity for accommodating the rechargeable battery is arranged between the first supporting piece and the second supporting piece.

By adopting the above-mentioned technical solution, when the temperature probe is produced and assembled by a manufacturer, the rechargeable battery may be put between the first supporting piece and the second supporting piece, and then, the first supporting piece and the second supporting piece are fixedly mounted by the fixing pieces, so that the mounting and producing efficiencies are increased. The first supporting piece and the second supporting piece are detachable, so that it is convenient for a user to replace the rechargeable battery after dismounting the support frame.

In some embodiments, the first supporting piece and/or the second supporting piece includes a supporting sheet, and the wireless charging coil is capable of sleeving the supporting sheet; and a wire through hole allowing a wire to penetrate is formed in the surface, close to the supporting sheet, of the first supporting piece and/or the second supporting piece.

By adopting the above-mentioned technical solution, the supporting sheets are capable of penetrating into the wireless charging coil to support the wireless charging coil, thereby providing mounting stability for the wireless charging coil. The wire through hole allows a wire between a master control circuit board and the rechargeable battery to penetrate.

In some embodiments, the fixing pieces are fixedly arranged on the first supporting piece, locating holes for accommodating the fixing pieces are formed in the second supporting piece, locating blocks are arranged in the locating holes, and the fixing pieces are provided with engagement bulges for engaging the locating blocks.

By adopting the above-mentioned technical solution, the fixing pieces are engaged with the locating blocks by the engagement bulges so that the first supporting piece and the second supporting piece are relatively fixed. The locating holes achieve an effect on locating the fixing pieces and improve the stability of engagement between the fixing pieces and the locating blocks, so that the first supporting piece and the second supporting piece are not easy to separate. The first supporting piece and the second supporting piece are fixedly arranged in an engagement manner so as to be conveniently mounted or dismounted by a user.

A second aspect of the present application is to provide an intelligent cooking utensil having the characteristics that the disposable use cost is reduced and the environmental friendliness is higher.

The above-mentioned second inventive aspect of the present application is achieved by the following technical solution: provided is an intelligent cooking utensil, including the temperature probe of any one of the above-mentioned descriptions and a pot cover for mounting the temperature probe, wherein the pot cover includes a mounting hole, and the metal head penetrates into the mounting hole.

### BRIEF DESCRIPTION OF THE DRAWINGS

FIG. 1 is a schematic diagram showing a structure of a temperature probe in a first embodiment of the present application;

FIG. 2 is a sectional view taken along a line A-A in FIG. 1;

FIG. 3 is a schematic diagram showing the assembly of a rear cover, a support frame, a housing, and a head sealing ring;

FIG. 4 is a schematic diagram showing that the temperature probe is in a charging state;

FIG. 5 is a diagram showing that a first supporting piece and a second supporting piece are in a combined state;

FIG. 6 is an exploded view of the first supporting piece and the second supporting piece;

FIG. 7 is a schematic diagram showing a working state of a temperature probe in a second embodiment of the present application;

FIG. 8 is an exploded view of a rear cover of a temperature probe in a third embodiment of the present application;

FIG. 9 is a front view of an intelligent cooking utensil with a temperature probe in a fourth embodiment of the present application; and

FIG. 10 is a front view of an intelligent cooking utensil with a temperature probe in a fifth embodiment of the present application.

### DETAILED DESCRIPTION

In order to make objectives, technical solutions and advantages of the embodiments of the present application clearer, the technical solutions in the embodiments of the present application will be described clearly and completely below in conjunction with the accompanying drawings in the embodiments of the present application. Obviously, the described embodiments are a part of the embodiments of the present application, not all the embodiments. Based on the embodiments in the present application, all other embodiments obtained by those of ordinary skill in the art without creative work shall fall within the protection scope of the present application.

In addition, the term “and/or” described herein merely describes an association relationship among associated objects and denotes that three relationships may exist. For example, A and/or B may denote three situations that A exists alone; A and B exist at the same time; and B exists alone. In addition, the character “/” described herein generally denotes that forward and backward associated objects are in an “or” relationship unless otherwise noted.

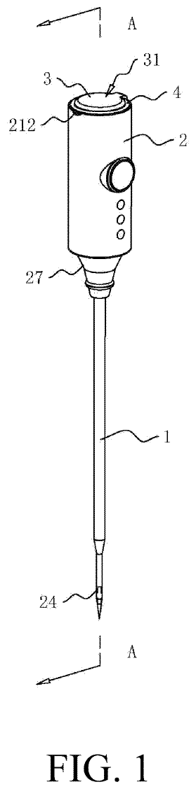

The embodiments of the present application are further described in detail below in conjunction with FIG. 1 to FIG. 10 of the description.

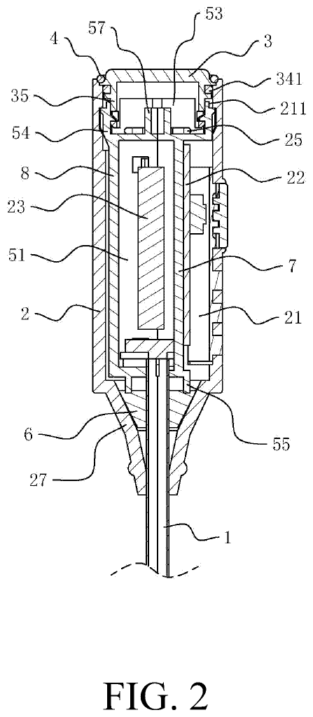

First embodiment: the first embodiment of the present application discloses a temperature probe. Referring to FIG. 1 to FIG. 2, the temperature probe includes a metal head 1 and a housing 2 for transferring heat, wherein the metal head 1 is fixedly mounted at one end of the housing 2. The housing 2 is shaped like a circular tube as a whole, a mounting cavity 21 is arranged in the housing 2, and a mounting opening 211 is formed in the end surface of the end, which communicates with the housing 2 and is away from the metal head 1, of the mounting cavity 21. The mounting opening 211 may be used for mounting electronic elements of the temperature probe into the mounting cavity 21, and the housing 2 is further provided with a rear cover 3 for sealing the mounting opening 211.

Referring to FIG. 1 to FIG. 2, the rear cover 3 is cylindric as a whole, one end of the rear cover 3 is accommodated in the mounting opening 211, and the other end of the rear cover 3 is exposed out of the mounting cavity 21 and is protruded to form a flat surface 31. Preferably, the metal head 1 is cylindric as a whole, and the flat surface 31 is perpendicular to the axis of the metal head 1. When the temperature probe is arranged in a vertical direction as a whole, that is, when the axis of the metal head lis perpendicular to a horizontal plane, the flat surface 31 is parallel to the horizontal plane. When a user needs to put the temperature probe on a fixed object such as a tabletop, the metal head 1 may be upward, and the housing 2 is put on the fixed object in the vertical direction.

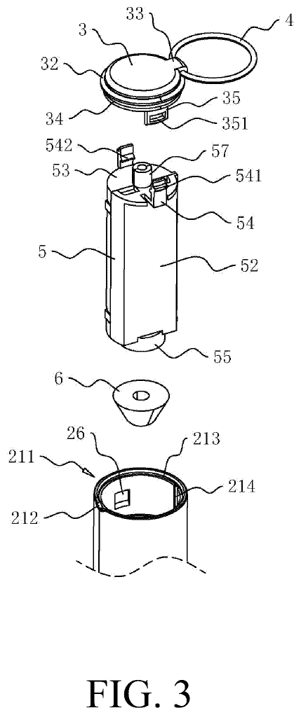

Referring to FIG. 3, preferably, the temperature probe is further provided with a hanging ring 4 for hanging a hanging object such as a hanging hook, an accommodating groove 32 for accommodating the hanging ring 4 is recessed in the end surface of the rear cover 3, the rear cover 3 is fixedly provided with an engagement hook 33 used to be matched with the accommodating groove 32 to fix the hanging ring 4, the engagement hook 33 is L-shaped as a whole, an opening of the engagement hook 33 faces the accommodating groove 32, and an opening of the accommodating groove 32 faces the engagement hook 33. The hanging ring 4 is accommodated between the opening of the engagement hook 33 and the opening of the accommodating groove 32, and the engagement hook 33 and the accommodating groove 32 are matched to engage and limit the hanging ring 4, so that the hanging ring 4 is mounted on the rear cover 3. Moreover, the hanging ring 4 is capable of rotating between the engagement hook 33 and the accommodating groove 32, so that the rear cover 3 is rotatably connected with the hanging ring 4.

In a normal use state, the hanging ring 4 is partially accommodated in the accommodating groove 32; and in an idle state, the hanging ring 4 may be partially separated from the accommodating groove 32 in a manner that the hanging ring 4 is rotated by a user, and then, the hanging ring 4 is hung on the corresponding hanging hook. Preferably, a finger location 212 is further arranged on the end surface of the mounting opening 211, and when the hanging ring 4 is accommodated in the accommodating groove 32, the user may force the hanging ring 4 apart by the finger location 212.

Referring to FIG. 2 and FIG. 3, in order to enhance the sealing property of the temperature probe, a sealing slot 34 is formed in the peripheral wall of the end, entering the mounting opening 211, of the rear cover 3, a circular tail sealing ring 341 is arranged in the sealing slot 34, and the tail sealing ring 341 is embedded and engaged into the sealing slot 34. When the rear cover 3 is mounted in the mounting opening 211, the rear cover 3 and the housing 2 are matched to extrude the tail sealing ring 341, so that the tail sealing ring 341 deforms and fill a gap between the rear cover 3 and the housing 2.

Referring to FIG. 1 and FIG. 2, a master control circuit board 22 and a rechargeable battery 23 are arranged in the housing 2, a temperature sensing element 24 is arranged on the end of the metal head, and each of the rechargeable battery 23 and the temperature sensing element 24 is electrically connected to the master control circuit board 22. The temperature sensing element 24 is fixedly mounted on one end of the metal head 1; and the master control circuit board 22 is further electrically connected with a wireless communication module and is used for transmitting temperature data measured by the temperature sensing element 24 to a remote terminal in a wireless communication manner. The temperature sensing element 24 is electrically connected to a charging circuit of the rechargeable battery 23, so that the rechargeable battery 23 is capable of supplying electric energy to the temperature sensing element 24. The structural principle of a control circuit of the charging circuit of the rechargeable battery 23 is the same as that of a control circuit of a wireless charging device in the prior art, the charging circuit itself is not improved in the present application, and therefore, a specific control principle of the control circuit is not repeatedly described herein. In the present embodiment, a wireless charging coil 25 is further arranged in the housing 2, and each of the wireless charging coil 25 and the rechargeable battery 23 is electrically connected to the master control circuit board 22.

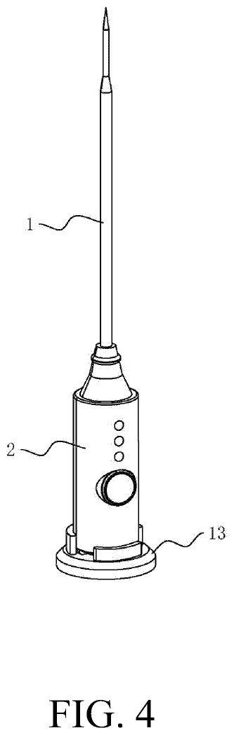

Referring to FIG. 2 and FIG. 3, in order to support and fix the electronic elements in the housing 2, a support frame 5 is arranged in the housing 2. The support frame 5 is distributed in a length direction of the housing 2 as a whole and is set to be hollow, an accommodating cavity 51 is formed in the support frame 5, and the rechargeable battery 23 is fixedly arranged in the accommodating cavity 51. A mounting surface 52 is arranged on the outer side of the support frame 5, and the master control circuit board 22 is fixedly arranged on the mounting surface 52. An accommodating space 53 is arranged on the end, close to the mounting opening 211, of the support frame 5, and the wireless charging coil 25 is fixedly mounted in the accommodating space 53. When the rear cover 3 is fixedly mounted in the mounting opening 211, the rear cover 3 is capable of shielding the electronic elements in the housing 2, thereby avoiding the phenomenon that water, oil or sundries enter the housing 2 to affect the electronic elements. When a user needs to charge the temperature probe, the rear cover 3 may be used as a bottom, and the housing 2 is put on a matched wireless charging mount 13 (referring to FIG. 4) in a vertical direction.

Referring to FIG. 3, a plurality of connecting pieces 54 are fixedly arranged on the end, close to the rear cover 3, of the support frame 5, and all the connecting pieces 54 are circumferentially distributed around the axis of the housing 2. First engagement portions 541 are protruded on the sides, close to the inner wall of the housing 2, of the connecting pieces 54, a plurality of engagement slots 26 for accommodating the plurality of first engagement portions 541 are formed in the inner wall of the housing 2, and the distribution of all the engagement slots 26 corresponds to the distribution of all the first engagement portions 541. When the support frame 5 is mounted in the housing 2, all the first engagement portions 541 are engaged in the adjacent engagement slots 26, so that the support frame 5 may be fixedly arranged in the housing 2. In the present embodiment, provided are two connecting pieces 54.

Referring to FIG. 2 and FIG. 3, in order to keep the first engagement portions 541 and the engagement slots 26 in a relatively stable engagement state and also enhance the sealing property of the end, away from the tail sealing ring 341, of the housing 2, a head sealing ring 6 is arranged on the end, close to the metal head 1, of the housing 2. An abutting sealing portion 55 is arranged on the end, away from the connecting pieces 54, of the support frame 5, and the abutting sealing portion 55 abuts against the head sealing ring 6 so as to be matched with the housing 2 to extrude the head sealing ring 6. The first engagement portions 541 located in the engagement slots 26 may be kept in a state of contact with walls of the engagement slots 26 under the action of an elasticity of the head sealing ring 6, so that the support frame 5 may be fixedly arranged in the housing 2, and furthermore, the stability of engagement between the first engagement portions 541 and the engagement slots 26 is improved. Preferably, the abutting sealing portion 55 is circular as a whole to enhance a stress effect of the head sealing ring 6, so that the head sealing ring 6 deforms more uniformly.

Referring to FIG. 2 and FIG. 3, specifically, a tapered portion 27 is arranged on the end, close to the head sealing ring 6, of the housing 2, the internal diameter of the tapered portion 27 is gradually reduced in a direction away from the mounting opening 211, and the head sealing ring 6 is accommodated in the tapered portion 27. Meanwhile, a tapered surface corresponding to the tapered portion 27 is arranged at the periphery of the head sealing ring 6 to increase the area of contact between the head sealing ring 6 and the tapered portion 27, so that a better sealing effect is achieved. One end of the metal head 1 sequentially penetrates through the tail end of the tapered portion 27, the head sealing ring 6, the abutting sealing portion 55, and the support frame 5. In the present embodiment, the end, penetrating through the support frame 5, of the metal head 1 is further engaged with the support frame 5, so that the mounting stability of the metal head 1 is improved.

Referring to FIG. 2 and FIG. 3, in order to fix the rear cover 3, second engagement portions 542 are protruded on the surfaces, away from the first engagement portions 541, of all the connecting pieces 54, the rear cover 3 is fixedly provided with a plurality of mounting blocks 35 in one-to-one correspondence to all the connecting pieces 54, and engagement holes 351 for engaging the adjacent second engagement portions 542 are formed in the mounting blocks 35. When the rear cover 3 is mounted in the mounting opening 211, all the second engagement portions 542 are engaged in the adjacent engagement holes 351 to stop the rear cover 3 from being separated from the mounting opening 211; and meanwhile, all the mounting blocks 35 are fitted to the adjacent connecting pieces 54. Since the mounting blocks 35 are located on the surfaces, away from the engagement slots 26, of the connecting pieces 54, the connecting pieces 54 are difficult to bend and deform in a direction away from the engagement slots 26, and thus, the stability of engagement between the first engagement portions 541 and the engagement slots 26 is improved.

Referring to FIG. 3, in the present embodiment, an avoiding slot 213 is further formed in the edge part of the inner wall of the mounting opening 211. When the rear cover 3 is engaged and fixed with the support frame 5, the peripheral edge part of the rear cover 3 may be partially accommodated in the avoiding slot 213, and the avoiding slot 213 has an effect on limiting the rear cover 3 so as to stop the rear cover 3 from further moving in a direction of entering the housing 2.

Referring to FIG. 3, when the housing 2, the support frame 5 and the rear cover 3 are assembled by a user, firstly, the support frame 5 is enabled to enter the mounting cavity 21 via the mounting opening 211, the abutting sealing portion 55 is enabled to be in contact with the head sealing ring 6, and all the first engagement portions 541 are enabled to be engaged and matched in the adjacent engagement slots 26; and then, the rear cover 3 is pushed into the mounting opening 211, all the mounting blocks 35 are enabled to be in contact with all the connecting pieces 54, and the second engagement portions 542 are enabled to be engaged and matched in the adjacent engagement holes 351. In order to increase the assembly efficiency and easily mount the support frame 5 or the mounting blocks 35, guide slopes are arranged on the surfaces, close to the support frame 5, of the first engagement portions 541, the surfaces, away from the support frame 5, of the second engagement surfaces 542, and the surfaces, away from the rear cover 3, of the mounting blocks 35.

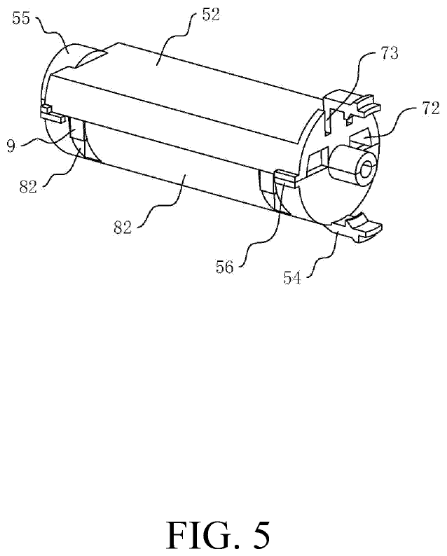

Referring to FIG. 3 and FIG. 5, further, a limiting block 56 is fixedly arranged on the outer side of the support frame 5, a limiting slot 214 slidably connected with the limiting block 56 is formed in the wall of the mounting cavity 21, and the limiting slot 214 communicates with the mounting opening 211. When the temperature probe is produced and assembled by a manufacturer, the limiting block 56 is capable of sliding into the limiting slot 214, and the support frame 5 may be gradually and completely pushed into the housing 2. When the first engagement portions 541 pass by the adjacent engagement slots 26, the first engagement portions 541 may be engaged with the adjacent engagement slots 26 with the further movement of the support frame 5 under the guide action of the limiting block 56, so that fixation between the support frame 5 and the housing 2 is achieved.

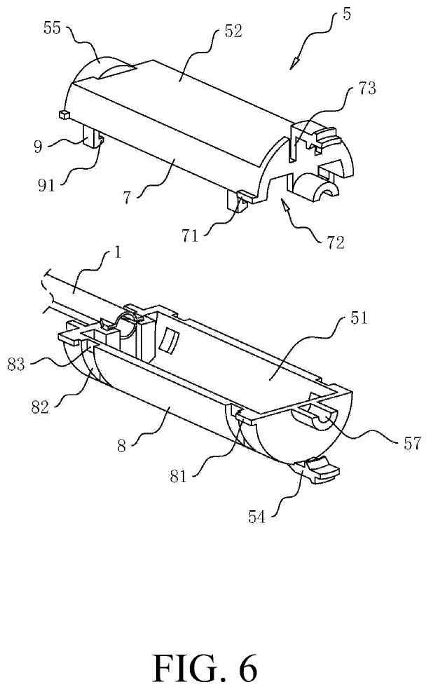

Referring to FIG. 6, in order to provide convenience for a user to mount the electronic elements into the support frame 5, the support frame 5 in the present embodiment is of a detachable split structure, the support frame 5 is composed of a first supporting piece 7 and a second supporting piece 8, and the first supporting piece 7 and the second supporting piece 8 are mounted and fixed by fixing pieces 9. The first supporting piece 7 and the second supporting piece 8 are juxtaposed in a length direction of the housing 2, and the two connecting pieces 54 are respectively arranged on the first supporting piece 7 and the second supporting piece 8. First limiting portions 71 are respectively and fixedly arranged on two ends of the first supporting piece 7, second limiting portions 81 are respectively and fixedly arranged on two ends of the second supporting piece 8, and the two first limiting portions 71 correspond to the two second limiting portions 81.

Referring to FIG. 6, a groove is formed in the middle of each of the first supporting piece 7 and the second supporting piece 8. When the first supporting piece 7 is combined and spliced with the second supporting piece 8, the complete accommodating cavity 51 is formed between the first supporting piece 7 and the second supporting piece 8, and the limiting block 56 is formed by combining and splicing the first limiting portions 71 and the adjacent second limiting portions 81. In the present embodiment, the first limiting portions 71 and the connecting pieces 54 are integrally formed on the corresponding first supporting piece 7; and the second limiting portions 81 and the connecting pieces 54 are integrally formed on the corresponding second supporting piece 8.

Referring to FIG. 6, specifically, provided are four fixing pieces 9, all the fixing pieces 9 are divided into two groups with each including two fixing pieces, the two groups of fixing pieces 9 are respectively located on two ends of the first supporting piece 7, and engagement bulges 91 are protruded on the ends, away from the first supporting piece 7, of the fixing pieces 9. Four locating holes 82 for accommodating all the fixing pieces 9 are formed in the outer side of the second supporting piece 8, and locating blocks 83 are fixedly arranged in all the locating holes 82. When the first supporting piece 7 and the second supporting piece 8 are in a fixed state, all the fixing pieces 9 are accommodated in the adjacent locating holes 82, and the locating blocks 83 located on the fixing pieces 9 are engaged with the adjacent locating blocks 83.

Referring to FIG. 2 and FIG. 6, when the temperature probe is assembled by a user, the electronic elements such as the rechargeable battery 23 may be mounted and fixed between the first supporting piece 7 and the second supporting piece 8, then, the fixing pieces 9 are mounted in the corresponding locating holes 82 and are engaged and matched with the locating blocks 83. In order to facilitate mounting the fixing pieces 9, wedged surfaces are arranged on the surfaces of the engagement bulges 91, so that the fixing pieces 9 are easier to deform when the engagement bulges 91 are engaged with the locating blocks 83. When the user needs to dismount the support frame 5 to replace the electronic elements, all the fixing pieces 9 may be forced apart, so that the fixing pieces 9 are not engaged with the locating blocks 83.

Referring to FIG. 2, further, a supporting sheet 57 is further arranged in the accommodating space 53, and the supporting sheet 57 penetrates into the wireless charging coil 25 so as to support the wireless charging coil 25. In the present embodiment, each of the first supporting piece 7 and the second supporting piece 8 includes the supporting sheet 57. In some embodiments, any one of the first supporting piece 7 and the second supporting piece 8 includes the supporting sheet 57. The wireless charging coil 25 is further respectively bonded with the first supporting piece 7 and the second supporting piece 8 so as to provide mounting stability.

Referring to FIG. 6, in the present embodiment, the mounting surface 52 is arranged on the first supporting piece 7, a wire through hole 72 is formed in the surface, close to the accommodating space 53, of the first supporting piece 7, the wire through hole 72 communicates with the accommodating cavity 51 and the accommodating space 53, and a wire between the master control circuit board 22 and the rechargeable battery 23 may penetrate into the wire through hole 72. A wire winding hole 73 is further formed in the first supporting piece 7, the wire winding hole 73 is of a through hole structure, and a wire among the wireless charging coil 25, the master control circuit board 22 and the rechargeable battery 23 may penetrate into the wire winding hole 73.

Referring to FIG. 6, in some embodiments, if the mounting surface 52 is arranged on the second supporting piece 8, the wire through hole 72 may also be formed in the surface, close to the accommodating space 53, of the second supporting piece 8, or the wire through hole 72 is formed in each of the first supporting piece 7 and the second supporting piece 8, so that the maximum throughput of the wire is increased.

The first embodiment of the present application is based on the implementation principle: the metal head 1 is used to abut against a food material and transfer heat to the temperature sensing element 24 in real time, so that the temperature sensing element 24 is capable of measuring the temperature of the food material in real time. The rechargeable battery 23 is used for supplying power to the temperature sensing element 24 to maintain the normal work of the temperature sensing element 24. When the power of the rechargeable battery 23 is relatively low or used up, a user may put the temperature probe on the wireless charging mount 13 and make the wireless charging coil 25 close to a charging region of the wireless charging mount 13 to charge the rechargeable battery 23. The rechargeable battery 23 in the temperature probe can be repeatedly charged, so that the frequency that the battery needs to be replaced by the user is reduced, the disposable use cost is reduced, meanwhile, the discard rate of the battery is reduced, and environment pollution is relieved.

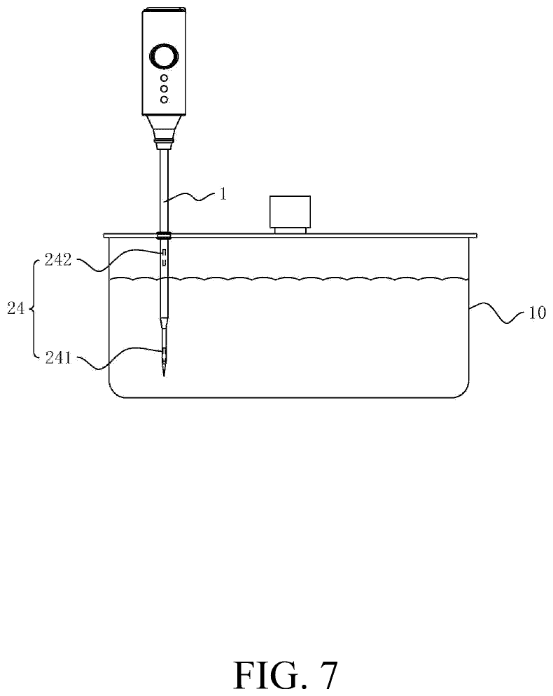

Second embodiment: referring to FIG. 7, the second embodiment of the present application discloses a temperature probe. The present embodiment is different from the first embodiment in that provided are two temperature sensing elements 24 which are respectively a first temperature sensing element 241 and a second temperature sensing element 242. The first temperature sensing element 241 is fixedly arranged on an end of the metal head 1, and the second temperature sensing element 242 is fixedly arranged in the middle of the metal head 2. During actual work, the first temperature sensing element 241 is capable of measuring the temperature of food material such as meat at the bottom inside a cooker 10, and the second temperature sensing element 242 is capable of measuring the temperature of air or food material such as water at the upper part inside the cooker 10.

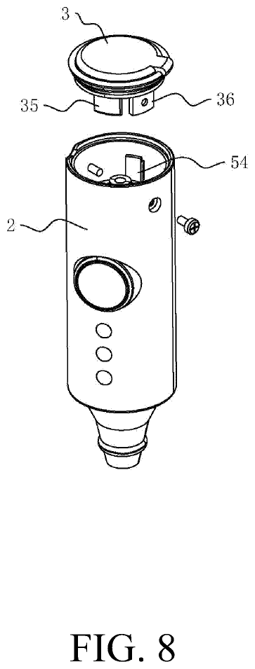

Third embodiment: referring to FIG. 8, the third embodiment of the present application discloses a temperature probe. The present embodiment is different from the first embodiment in that no engagement structure is arranged between the mounting blocks 35 and the connecting pieces 54, a plurality of fixing blocks 36 are integrally formed on the end, entering the mounting opening 211, of the rear cover 3, and the fixing blocks 36 are fixed with the housing 2 by using bolts 37. In the present embodiment, provided are two fixing blocks 36, and the two fixing blocks 36 are symmetrically distributed around the axis of the rear cover 3.

The rear cover 3 is detachably connected with the housing 2, and therefore, a user may take out the rear cover 3 from the housing 3 by screwing out the bolts 37, and then, take out the support frame 5 in the housing 2.

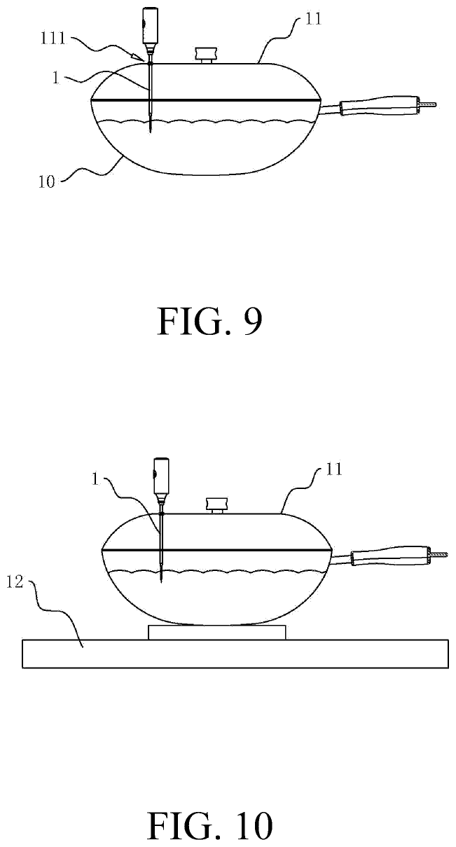

Fourth embodiment: referring to FIG. 9, the fourth embodiment of the present application discloses an intelligent cooking utensil. The intelligent cooking utensil includes a cooker 10, a pot cover 11 matched with the cooker 10, and an intelligent probe. The pot cover 11 defines a mounting hole 111, and a metal head 1 of the intelligent probe penetrates into the mounting hole 111. In order to improve the mounting stability of the intelligent probe, an elastic ring (not shown) is further arranged between the mounting hole 111 and the metal head 1. When a user performs cooking, food material may be put into the cooker 10 which is then covered by the pot cover 11, and the metal head 1 of the temperature probe is enabled to be in contact with the food material, so that the temperature of the food material is detected.

Fifth embodiment: referring to FIG. 10, the fifth embodiment of the present application discloses an intelligent cooking utensil. The present embodiment is different from the fourth embodiment in that the intelligent cooking utensil further includes an intelligent cooking stove 12, and a communication module and a control module are arranged in the intelligent cooking stove 12, wherein the communication module is used for receiving temperature information transmitted by the temperature probe, and the control module is used for controlling and adjusting the heat power of the intelligent cooking stove 12 according to the temperature information. Specifically, the communication module may be one or a combination of a Bluetooth module, a WIFI module, a 4g module and a 5g module. In the present embodiment, the communication module is preferably the Bluetooth module. The control module is preferably a single chip microcomputer.

The above descriptions are preferred embodiments of the present application, and are not intended to limit the protection scope of the present application. Therefore, equivalent changes made according to the structure, shape and principle of the present application shall fall within the protection scope of the present application.

What is claimed is:

1. A temperature probe, comprising a housing, a metal head fixedly arranged on the housing, and a temperature sensing element arranged in the metal head;
a wireless charging coil, a rechargeable battery and a support frame for supporting the wireless charging coil and the rechargeable battery are arranged in the housing; the temperature sensing element being electrically connected to a charging circuit of the rechargeable battery; and the wireless charging coil being electrically connected to the rechargeable battery so as to charge the rechargeable battery.

2. The temperature probe of claim 1, wherein the support frame comprises a plurality of first engagement portions, and a plurality of engagement slots for engaging and matching the adjacent first engagement portions are formed in the inner side of the housing.

3. The temperature probe of claim 2, wherein the support frame comprises a limiting block, a limiting slot for limiting the limiting block is formed in the housing, and the sliding block is slidably connected to the inside of the limiting slot; and the positions of the engagement slots pass by sliding paths of the first engagement portions.

4. The temperature probe of claim 2, wherein the housing comprises a head sealing ring for sealing a gap between the metal head and the housing, and one end of the support frame comprises an abutting sealing portion for abutting against the head sealing ring to achieve a sealing effect.

5. The temperature probe of claim 1, wherein the housing comprises a mounting cavity for accommodating the support frame, one end of the mounting cavity is provided with a mounting opening allowing the support frame to enter and exit, an accommodating space for accommodating the wireless charging coil is arranged between the mounting opening and an end of the support frame, and a rear cover for shielding the accommodating space is detachably mounted in the mounting opening.

6. The temperature probe of claim 5, wherein the support frame comprises a plurality of first engagement portions, and a plurality of engagement slots for engaging and matching the adjacent first engagement portions are formed in the inner side of the housing; the support frame comprises connecting pieces for connecting the first engagement portions, the rear cover comprises mounting blocks having a function of limiting the connecting pieces; and
the connecting pieces are provided with second engagement portions, and the mounting blocks are provided with engagement holes for engaging the adjacent second engagement portions.

7. The temperature probe of claim 1, wherein the support frame comprises a first supporting piece, a second supporting piece assembled and matched with the first supporting piece, and fixing pieces for detachably fixing the first supporting piece and the second supporting piece; and an accommodating cavity for accommodating the rechargeable battery is arranged between the first supporting piece and the second supporting piece.

8. The temperature probe of claim 7, wherein the first supporting piece and/or the second supporting piece comprises a supporting sheet, and the wireless charging coil is capable of sleeving the supporting sheet; and a wire through hole allowing a wire to penetrate is formed in the surface, close to the supporting sheet, of the first supporting piece and/or the second supporting piece.

9. The temperature probe of claim 7, wherein the fixing pieces are fixedly arranged on the first supporting piece, locating holes for accommodating the fixing pieces are formed in the second supporting piece, locating blocks are arranged in the locating holes, and the fixing pieces are provided with engagement bulges for engaging the locating blocks.

10. An intelligent cooking utensil, comprising the temperature probe of claim 1 and a pot cover for mounting the temperature probe, wherein the pot cover comprises a mounting hole, and the metal head penetrates into the mounting hole.
